(19) United States
(12) Patent Application Publication
(10) Pub. No.: US 2009/0044901 A1
(43) Pub. Date: Feb. 19, 2009

(54) Heat conducting glue and a method for joining metallic plate materials together with the glue

(76) Inventor: Tseng-Jung Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/889,868

(22) Filed: Aug. 17, 2007

(51) Int. Cl. B32B 37/02; B32B 38/10

(52) U.S. Cl. 156/247; 428/41.8

(57) ABSTRACT

A kind of heat conducting glue comprises heat conducting resin, and release films on two sides of the heat conducting resin; the heat conducting glue is made by means of applying conducting resin to a first release film, baking the heat conducting resin to a certain degree, heating and pressing the heat conducting resin so as stick the heat conducting resin on a second release film, and making the heat conducting glue become a roll; two metallic plate materials are joined together by means of detaching the first release film from the heat conducting resin, sticking the heat conducting resin on one of the metallic plate materials, detaching the second release film, and pressing the other metallic plate material and the heat conducting resin against each other to join them together.

### BACKGROUND OF THE INVENTION

1. Field of the Invention

The present invention relates to a heat conducting glue and a method for joining two metallic plate materials together with the heat conducting glue; with the present invention, the heat conducting glue is formed in such a way as not to cause noticeable increase to the thickness and volume of metallic plate materials joined together therewith, and the glue have relatively good heat conductivity.

2. Brief Description of the Prior Art

Metallic plate materials were joined together with adhesive films in early years. Such adhesive films have heat conductivity, and they are glass fibers coated with functional resin such as phenolic aldehyde and epoxy resin; the glass fibers can be soaked in resin to be coated with the functional resin; or alternatively, resin can be sprinkled on the glass fibers. The above functional resin doesn't have very good heat conductivity therefore heat conductivity of the metallic plate materials will reduce after they are joined together with the adhesive films. Consequently, the metallic plate materials can't help to dissipate heat in a satisfactory manner.

For the above reason, the industry developed various more highly heat conductive adhesive films for joining metallic plate materials together, which are coated with a mixture of functional resin and various heat conducting materials.

The above improvements on heat conducting adhesive films have the following drawbacks: deficiency such as air bubbles is prone to come into existence on the glass fibers when functional resin is joined to the glass fibers. Second, because of the glass fiber materials joined, it is relatively difficult to apply high temperature solder (>300° C.) on PCB production process. Third, the adhesive films are relatively thick. Consequently, the heat conductivity of the metallic plate materials will reduce after they are joined together with the adhesive films. Fifth, very noticeable difference exists between the various heat conducting adhesive films in respect of heat conductivity, stability, and rate of defective products. Therefore, there is room for improvement.

### SUMMARY OF THE INVENTION

It is a main object of the present invention to provide a heat conducting glue to overcome the above problems. The heat conducting glue is used to join plate materials for LED heat dissipation plates, heat dissipation plates of backlight modules of LCD, heat dissipation plates of car LED, heat dissipation plates of lighting LED, various electronic devices such as power suppliers, and various plates intended to help to dissipate heat.

A kind of heat conducting glue according to an embodiment of the present invention comprises heat conducting functional resin, and release films on two sides of the heat conducting functional resin; the heat conducting glue is made by means of applying heat conducting functional resin to a first release film, baking the heat conducting resin to a certain degree, heating and pressing the heat conducting functional resin so as stick the heat conducting resin on a second release film, and making the heat conducting glue become a roll; two metallic plate materials are joined together by means of detaching the first release film from the heat conducting resin, sticking the heat conducting resin on one of the metallic plate materials, detaching the second release film, and pressing the other metallic plate material and the heat conducting functional resin against each other.

### BRIEF DESCRIPTION OF THE DRAWINGS

The present invention will be better understood by referring to the accompanying drawings, wherein:

FIG. 1 is a view of the heat conducting functional resin of the present invention under production process (1),

FIG. 2 is a view of the heat conducting functional resin of the present invention under production process (1),

FIG. 3 is a view used to illustrate a first step of the sticking method of the present invention,

FIG. 4 is a view used to illustrate a second step of the sticking method of the present invention,

FIG. 5 is a view used to illustrate a third step of the sticking method of the present invention,

FIG. 6 is a view used to illustrate a fourth step of the sticking method of the present invention, and

FIG. 7 is a view used to illustrate a fifth step of the sticking method of the present invention.

### DETAILED DESCRIPTION OF THE PREFERRED EMBODIMENTS

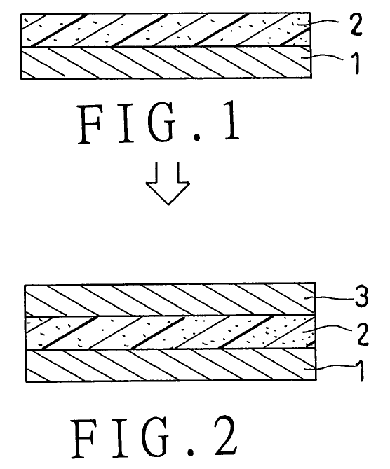

Referring to FIGS. 1 and 2 are sectional views of a preferred embodiment of a heat conducting glue of the present invention under a production process. According to the production process, first heat conducting functional resin 2 is applied to a first release film 1 by means of an application machine/tool. Second, the heat conducting functional resin 2 is baked to a certain degree, e.g. B-stage state, by means of a baking device. Third, the heat conducting functional resin 2 is heated and pressed by means of a heating and pressing device so that it is stuck on a second release film 3 at the other side thereof.

The detachment films 1 and 3 can be a PET release film or a PEN one, and they can be coated with either silicon or melamine. The release force of the release films 1 and 3 ranges between 20 g/cm and 300 g/cm.

The heat conducting functional resin 2 comprises 10% to 35% of epoxy resins with an epoxy equivalent weight of 300 to 500, 0% to 10% of epoxy resins with an epoxy equivalent weight of 100 to 200, 0% to 25% of formulated resin, which is a mixture substance including at least one of polyester, BR (butylenes rubber), NBR (Butadiene Acrylontrile rubber), and PI (polyimide), 30% to 80% of filling powder, which is a mixture substance including at least one of Al₂O₃, AlN (Aluminum Nitride), BN, and SiC, 0.1% to 0.2% of antioxidants, and 1.5% to 10% of cross-linking agent, which is a mixture substance of at least one of hardening amide agent, and acid anhydrous compound series of hardening agents.

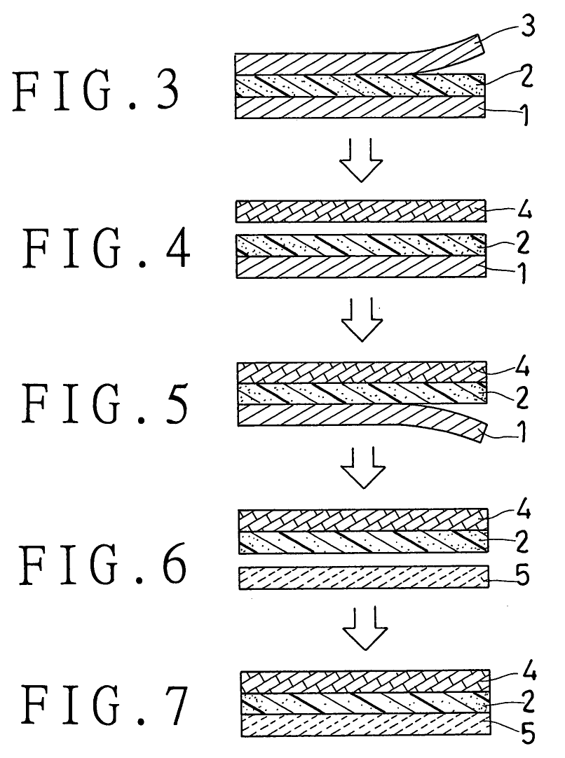

The heat conducting functional resin 2 is provided for joining two metallic plate materials together. Referring to FIG. 3 to FIG. 7, first the one of the release films 1 and 3 is detached from the heat conducting functional resin 2. Second, the heat conducting functional resin 2 is stuck on a first metallic plate material 4, whose surface has already been cleaned and processed, pressed with a pressure of over 2 kg at a temperature of over 100° C.; the first metallic plate material 4 can be a pure aluminum plate, an aluminum alloy plate, a copper plate or an iron plate. Third, the other one of the release films 1 and 3 is detached from the heat conducting functional resin 2, and next a second metallic plate material 5 and the heat conducting functional resin 2 are pressed together; thus, the first and the second metallic plate materials 4 and 5 are joined together; the second metallic plate material 5 can be a copper foil, e.g. an electroplated (ED) copper foil, and a RA copper foil formed by means of rolling such that the metallic plate materials 4 and 5 can be used for production of circuit boards.

From the above description, it can be seen that the present invention has the following advantages: heat conducting resin is applied between two release films, which serve as a carrying means for the heat conducting resin, and the heat conducting resin is baked to a certain degree therefore the heat conducting resin can be used to join two metallic plate materials together in a production process; second, the heat conducting resin can be rolled up into a roll, and in turns they can be mass-produced, and are suitable for use in mass production of metallic plate materials. Therefore, the present invention is practical.

What is claimed is:

1. A kind of heat conducting glue, comprising
heat conducting functional resin; and
first and second release films on two sides of the heat conducting functional resin;
in manufacturing: first, the first release film being coated with the heat conducting functional resin by means of an application machine;
second, the heat conducting functional resin being baked to a predetermined degree by means of a baking device; and
finally, the heat conducting functional resin being heated and pressed so as to be stuck on the second release film by means of a heating and pressing device.

2. The heat conducting glue as claimed in claim 1, wherein the heat conducting functional resin is baked to a B-stage state by means of a baking device.

3. The heat conducting glue as claimed in claim 1, wherein the release films are chosen from a group including PET release films coated with silicon, PET release films coated with melamine, PEN release films coated with silicon, and PEN release films coated with melamine.

4. The heat conducting glue as claimed in claim 1, wherein the release films have a detachment force ranging between 20 and 300 g/cm.

5. The heat conducting glue as claimed in claim 1, wherein the heat conducting functional resin comprises 10% to 35% of epoxy resins with an epoxy equivalent weight of 300 to 500, 0% to 10% of epoxy resins with an epoxy equivalent weight of 100 to 200, 0% to 25% of formulated resin, 30% to 80% of filling powder, 0.1% to 0.2% of antioxidants, and 1.5% to 10% of cross-linking agent.

6. The heat conducting glue as claimed in claim 5, wherein the formulated resin is a mixture of polyester, BR (butylenes rubber), NBR (Butadiene Acrylontrile rubber), and (PI polyimide).

7. The heat conducting glue as claimed in claim 5, wherein the filling powder is a mixture of Al₂O₃, AlN (Aluminum Nitride), BN, and SiC.

8. The heat conducting glue as claimed in claim 5, wherein the cross-linking agent is a mixture of hardening amide agent and acid anhydrous compound series of hardening agents.

9. A method for fastening metallic plate materials together with heat conducting glue, comprising following steps:
applying heat conducting functional resin in order for the heat conducting functional resin to be sandwiched between first and second release films;
detaching one of the release films from the heat conducting functional resin;
sticking the heat conducting functional resin on a first metallic plate material, whose surface has already been cleaned and processed, pressed with a pressure of over 2 kg at a temperature of over 100° C.;
detaching other one of the release films from the heat conducting functional resin; and
pressing a second metallic plate material and the heat conducting functional resin against each other to join same together.

10. The method for fastening metallic plate materials together with heat conducting glue as claimed in claim 9, wherein the metallic plate materials are aluminum plates.

11. The method for fastening metallic plate materials together with heat conducting glue as claimed in claim 10, wherein the aluminum plates are made of pure aluminum.

12. The method for fastening metallic plate materials together with heat conducting glue as claimed in claim 10, wherein the aluminum plates are made of aluminum alloy.

13. The method for fastening two metallic plate materials together with heat conducting glue as claimed in claim 9, wherein the metallic plate materials are copper plates.

14. The method for fastening metallic plate materials together with heat conducting glue as claimed in claim 9, wherein the metallic plate materials are iron plates.

15. The method for fastening metallic plate materials together with heat conducting glue as claimed in claim 9, wherein the metallic plate materials are copper foils.

16. The method for fastening metallic plate materials together with heat conducting glue as claimed in claim 15, wherein the copper foils are electroplated ones.

17. The method for fastening metallic plate materials together with heat conducting glue as claimed in claim 15, wherein the copper foils are RA copper foils.

18. The method for fastening metallic plate materials together with heat conducting glue as claimed in claim 9, wherein the metallic plate materials joined together with the heat conducting glue are used for production of circuit boards.
